(19) United States
(12) Patent Application Publication
(10) Pub. No.: US 2019/0199519 A1
(43) Pub. Date: Jun. 27, 2019

(54) DETECTING AND TREATING UNAUTHORIZED DUPLICATE DIGITAL CONTENT

(71) Applicant: Microsoft Technology Licensing, LLC, Redmond, WA (US)

(72) Inventors: Vineet Goyal, Bengaluru (IN); Sachin Kakkar, Karnataka (IN)

(21) Appl. No.: 15/898,601

(22) Filed: Feb. 18, 2018

(30) Foreign Application Priority Data
Dec. 26, 2017 (IN) 201741046725

(51) Int. Cl. H04L 9/06; G06F 21/10; G06F 21/62; G06F 17/30

(52) U.S. Cl. CPC H04L 9/0643; G06F 21/10; H04L 67/02; G06F 17/30867; H04L 2209/603; G06F 21/6218

(57) ABSTRACT

A machine may be configured to perform detecting and treating unauthorized duplicate digital content. For example, the machine accesses a digital content item published on a server of a social networking service (SNS) by a member of the SNS. The machine determines that the digital content item does not include a reference indicator that indicates that the digital content item is copied original content. The machine determines that the digital content item is at least one of a near-duplicate or an exact duplicate of an original digital content item based on a comparison between data pertaining to the digital content item and data pertaining to the original digital content item. The machine enhances the server based on executing a treatment of the digital content item. The executing of the treatment includes causing an automatic alteration of a state associated with the digital content item in the record of the database.

### RELATED APPLICATIONS

The present patent application claims the priority benefit of the filing date of Indian Application No. 201741046725 filed Dec. 26, 2017, the entire content of which is incorporated herein by reference.

### TECHNICAL FIELD

The present application relates generally to systems, methods, and computer program products for detecting and treating unauthorized duplicate digital content.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” (hereinafter, also “SNS”) are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

The social networking service may provide functionality for posting, by the users of the social networking service, of digital content on a server associated the social networking service. Examples of digital content items are articles, comments, recommendations, photographs, videos, etc. The digital content items may be published on the SNS in various ways' on a profile page of a member of the SNS, in a feed of a member of the SNS, in a comment, in a recommendation, etc. Generally, the digital content items published on the SNS are items of original digital content that were authored by the members of the SNS who uploaded the digital content to a server of the SNS. In some instances, a member of the SNS may engage in an unauthorized copying and publishing on the SNS of items of digital content that were authored by other entities (e.g., another person, organization, or company).

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments,

FIG. 2 is a block diagram illustrating components of a content treatment system, according to some example embodiments;

FIG. 3 is a flowchart illustrating a method for detecting and treating unauthorized duplicate digital content, according to some example embodiments;

FIG. 4 is a flowchart illustrating a method for detecting and treating unauthorized duplicate digital content, and representing additional steps of the method illustrated in FIG. 3, according to some example embodiments;

FIG. 5 is a flowchart illustrating a method for detecting and treating unauthorized duplicate digital content, and representing additional steps of the method illustrated in FIG. 4, according to some example embodiments,

FIG. 6 is a flowchart illustrating a method for detecting and treating unauthorized duplicate digital content, representing an additional step of the method illustrated in FIG. 3, and representing step 306 of the method illustrated in FIG. 3 in more detail, according to some example embodiments;

FIG. 7 is a flowchart illustrating a method for detecting and treating unauthorized duplicate digital content, and representing step 308 of the method illustrated in FIG. 6 in more detail, according to some example embodiments.

FIG. 8 is a flowchart illustrating a method for detecting and treating unauthorized duplicate digital content, and representing step 306 of the method illustrated in FIG. 3 more detail, according to some example embodiments;

FIG. 9 is a flowchart illustrating a method for detecting and treating unauthorized duplicate digital content, and representing step 308 of the method illustrated in FIG. 8 in more detail, according to some example embodiments.

FIG. 10 is a flowchart illustrating a method for detecting and treating unauthorized duplicate digital content, representing additional steps of the method illustrated in FIG. 3, and representing step 308 of the method illustrated in FIG. 3 in more detail according to some example embodiments,

FIG. 11 is a flowchart illustrating a method for detecting and treating unauthorized duplicate digital content, and representing additional steps of the method illustrated in FIG. 3, according to some example embodiments;

FIG. 12 is a flowchart illustrating a method for detecting and treating unauthorized duplicate digital content, and representing additional steps of the method illustrated in FIG. 3, according to some example embodiments, and

FIG. 13 is a block diagram illustrating components of a machine, according to some example embodiments, able to read instructions from a machine-readable medium and perform any one or more of the methodologies discussed herein.

### DETAILED DESCRIPTION

Example methods and systems for detecting and treating unauthorized duplicate digital content on a social networking service, such as LinkedIn®, are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

In some example embodiments, the SNS provides functionality for publishing, by the members of the SNS, of digital content on a server associated the SNS. The members of the SNS may post digital content items, such as articles, comments, recommendations, photographs, or videos, on the SNS using various communication channels provided by the SNS, on a profile page of a member of the SNS, in a feed of a member of the SNS, in a comment. In a recommendation, etc. Many of the digital content items published on the SNS are items of original digital content that were authored by the members of the SNS who uploaded the digital content to a server of the SNS. In some instances, a member of the SNS may engage in an unauthorized copying and publishing on the SNS of items of digital content that were authored by other entities (e.g., another person, organization, or company). Some members of the SNS may present (e.g., post or publish) content created by another as their own. Such plagiarizing, in various instances, may include infringement of the exclusive rights of a copyright owner of a work (e.g., literary, dramatic, musical, and artistic works, such as poetry, novels, photographs, movies, songs, computer software, and architecture). The unauthorized copying and publishing on the SNS of items of digital content may include re-posting on the SNS of digital content that was previously posted on the SNS by another member of the SNS (e.g., a first member re-publishes an article authored by a second member) with or without a signal that indicates that the published digital content is copied, or may include initial posting, by a member of the SNS, of another person's copyrighted work that was not previously posted on the SNS (e.g., the first member reproduces a copyrighted work of another person).

A computer system that manages or utilizes such published digital content items may require great amounts of storage space, and with time may become inefficient in processing the great amounts of data related to various digital content items. It would be beneficial to have an enhanced computer system (e.g., a content treatment system) that identifies near-duplicates or exact duplicates of original digital content items, and selects and executes various further actions (e.g., treatments) based on identified types of content duplication.

In various example embodiments, such a content treatment system accesses, at a record of a database, a digital content item. The digital content item is published on a server of the SNS by a member of the SNS. The content treatment system determines that the digital content item does not include a reference indicator that indicates that the digital content item is copied original content. The digital content item determines that the digital content item is at least one of a near-duplicate or an exact duplicate of an original digital content item based on a comparison between data pertaining to the digital content item and data pertaining to the original digital content item. The digital content item enhances the server based on executing a treatment of the digital content item. The treatment of the digital content item is based on the determining that the digital content item is at least one of the near-duplicate or the exact duplicate of the original digital content item. The executing of the treatment may include causing an automatic alteration of a state associated with the digital content item in the record of the database.

In some example embodiments, the content treatment system performs analysis and treatment of various digital content data in three phases (hereinafter also “flows”): an online phase, a nearline phase, and an offline phase. The online phase is performed in real-time after a digital content item is uploaded to a server of the SNS by a member of the SNS. The online phase, in some instances, takes milliseconds. During the online phase, the content treatment system determines that the digital content item does not include a reference indicator that indicates that the digital content item is cooled original content. The reference indicator may be a reference to an original author of the content included in the digital content item recently published, or a reference to the source of content (e.g., content copied from a website, or associated with an organization). In some instances, the reference indicator takes the form of a hashtag reference (e.g., “# copied,” “# copied from XYZ,” or “# non-original content”). The reference indicator may or may not indicate the actual author or source of the original content. In some instances, the determining that the digital content item does not include the reference indicator is performed based on pattern matching (e.g., comparing the content of the digital content item to one or more patterns that represent various reference indicators, such as “@copied,” “@member,” a source identifier, a Uniform Resource Locator (URL), etc.).

Also during the online phase, the content treatment system accesses the recently uploaded digital content item from a record of a database, generates a hash of the digital content item, accesses one or more other hashes of one or more other digital content items from a further record of the database, compares the hash of the digital content item and the one or more other hashes of one or more other digital content items, and determines that the digital content item is a near-duplicate of another (e.g., a further) digital content item based on matching the hash of the digital content item and the one or more other hashes of one or more other digital content items. Based on the determination that the digital content item is a near-duplicate item, the content treatment system may tag the recently uploaded digital content item as “low-quality content.”

The content treatment system may restrict the distribution of low-quality content (e.g., the recently uploaded digital content item) to the first-degree contacts of the member who posted the content, as identified based on the social graph of the member on the SNS. The restriction of the distribution of the recently uploaded digital content item is a particular treatment of one or more treatments that the content treatment system selects based on determining that the recently uploaded digital content item is a near-duplicate of another digital content item.

In various example embodiments, the content treatment system pre-processes the digital content item before generating a hash of the digital content item. The pre-processing, in some instances, includes: accessing a digital publication (e.g., a message published in a feed), and removing Personal Identifiable information (PII) from the digital publication. The removing of the PII results in a PII-free digital content item. The pre-processing may further include performing a canonicalization operation on the PII-free digital content item. The performing of the canonicalization operation results in the digital content item.

In some example embodiments, the generation and matching of hashes for a digital content item serves as basis for determining that the digital content item is a near-duplicate of an original digital content item. The content treatment system may, in various example embodiments, use a locality sensitive hash (LSH) model, a minHash model, a Jaccard similarity model, or a suitable combination thereof, to identify syntactic near-duplicates of an original digital content item from one or more recently received digital content items or from historical digital content items that were previously published on the SNS or stored in a database associated with the content treatment system.

For example, LSH hashing generates a unique “fingerprint” that uniquely identifies a particular digital content item. If two unique LSH fingerprints associated with two digital content items match to a certain high degree (e.g., 80%) then the content treatment system determines that the two digital content items are similar to that certain level (e.g., 80%). The high degree of similarity provides a high degree of confidence that the two digital content items are near-duplicates.

According to some example embodiments, the utilization of various near-duplication detection models (e.g., a hash model, a pattern model, a machine learning model, an image classification model, etc.), solely or in combination, increases a machine-determined confidence level that a certain digital content item is or is not a near-duplicate of an original digital content item.

In some example embodiments, the content treatment system performs further analysis of the recently uploaded digital content item in the nearline phase. During the nearline phase, the content treatment system accesses one or more original digital content items at a database record that stores original digital content items, compares one or more character strings (e.g., one or more words, one or more phrases, one or more sentences, etc.) included in the digital content item and one or more character strings included in the one or more original digital content items, and matches the one or more character strings included in the digital content item and one or more character strings included in a particular original digital content item. The nearline phase, in some instances, may last minutes or longer.

In some example embodiments, if the content treatment system determines that the digital content item does not include the reference indicator that indicates that the digital content item is copied original content, or that gives credit to the original author or source of content, the content treatment system identifies (e.g., marks, tags, or classifies in a category) the digital content item as plagiarized by the member (e.g., copied work that was created by another, and posted as their own).

The content treatment system may take down a published digital content item that uses (or includes) plagiarized content. The content treatment system may also identity the posting of the digital content item as a violation (e.g., unauthorized copying, plagiarizing, or copyright infringement), and may increase a counter associated with the member who posted the violating content. Based on a certain number of violations by the member, the content treatment system may restrict the member from logging into the SNS. In some instances, the content treatment system generates a reputation score value (or update a previously generated reputation score value) for the members of the SNS. For example, the member identifier (hereinafter, also “ID”) of a violating member is associated with a low reputation score value, and the member ID of a member determined to be an original author of digital content who does not plagiarize other members' digital content may be associated with a high reputation score value.

During the offline phase, the content treatment system identifies original digital content items and original authors, and generates a database of information pertaining to original content. Examples of original authors include a member of the SNS determined to be an original author of one or more digital content items, a person known to be the author of a well-known work of literature, art, music, architecture, etc., an organization that commissioned a copyrighted work (as a “work for hire”), etc. The offline phase, in some instances, takes hours, and may be run in parallel with the online phase and the nearline phase. In some example embodiments, the content treatment system analyzes historical (e.g., older, previously published) digital content items during the offline phase to identify and remove old duplicate digital content.

The content treatment system may, during the offline phase, analyze a multitude of digital content items stored on one or more server, and identify similar digital content. Two items of digital content are similar if they have a certain amount of overlapping content. The content treatment system may determine that a first digital content item and a second digital content item are similar if the overlapping content of the first digital content item and second digital content item equals or exceeds a certain threshold value (e.g., 50%, 70%, 80%, etc.). The similar digital content items may be clustered in a record of a database, and may be further analyzed to determine which one of the clustered digital content items is the original digital content item, and which ones are potentially plagiarized content.

In some example embodiments, the recently uploaded digital content item is a first digital content item. At a time prior to accessing the first digital content item, the content treatment system accesses, at the record of the database, a second digital content item (e.g., a further digital content item) and a third digital content item (e.g., yet a further digital content item). The content treatment system generates a hash of the second digital content item and a hash of the third digital content item based on applying a hash function to the second digital content item and the third digital content item. The content treatment system determines a degree of similarity between the hashes of the second digital content item and the third digital content item. The content treatment system determines that the degree of similarity between the hashes of the second digital content item and the third digital content item equals or exceeds a threshold value.

The content treatment system stores the hash of the second digital content item and the hash of the third digital content item in a hash cluster, at a further record of the database. The hashes are stored in association with respective time stamps that correspond to times of publishing of the second digital content item and the third digital content item on the server of the SNS, and with identifiers of members of the SNS who published the second digital content item and the third digital content item. The storing of the hashes in the hash cluster is based on determining that the degree of similarity between the hashes of the second digital content item and the third digital content item equals or exceeds a threshold value. In various example embodiments, each hash stored in the hash cluster is associated with an ID of the associated digital content item, a member ID of the member who posted the digital content item, a timestamp that indicates the time of the creation (e.g., posting or publishing) of the digital content item, and other metadata pertaining to the digital content item or the member.

The content treatment system may determine which digital content item of a plurality of similar digital content items is the original digital content item In various example embodiments, after the content treatment system stores the hash of the second digital content item and the hash of the third digital content item in the hash cluster, the content treatment system determines that a particular digital content item (e.g., the second digital content item) associated with a particular hash in the hash cluster is the original digital content item. The determining of the particular digital content item as the original content item, in some instances, is based on determining that the timestamp associated with the particular hash of the particular digital content item indicates that the particular digital content item is the earliest in the chronological order in the hash cluster. In some instances, the reputation score value associated with the members who posted the similar digital content items also serves as basis for determining whether the particular digital content item is identified as the original digital content item. For example, a member who is an influence, a non-fraudulent member, or a member who is associated with activities that do not violate any SNS policies is assigned a higher reputation score value than a member who previously was associated with fraudulent activities, or has previously posted plagiarized content (e.g., a counter value of a counter of plagiarized content postings for the member is higher than zero).

Upon determining that the particular digital content item is the original digital content item, the content treatment system stores the second digital content item as the original digital content item in association with a member ID of a particular member who posted the particular digital content item (e.g., a second member of the SNS) in an original content record of the database. The particular member is identified as the original author (hereinafter also “author”) of the original digital content item. The content treatment system also associates the member ID of the particular member with a reputation score value that indicates that the second member is the author of the original digital content item.

As discussed above, the hashes included in the hash cluster are hashes of similar digital content items. Also during the offline phase, the content treatment system determines that the hashes included in the hash cluster, with the exception of the hash of the original digital content item, are hashes of digital content items that were copied and posted without authorization from the original author.

In some example embodiments, some plagiarizing members may add a reference identifier (e g., “# copied”) to copied content in an attempt to work around a requirement to obtain permission from the original author to re-publish original content. The content treatment system treats the reference identifier associated with a particular digital content item as an indicator that the content included in the particular digital content item is worthy of plagiarizing by plagiarizing members, generates a hash of the particular digital content item, and compares hashes of recently received digital content items and the hash of the particular digital content item. As such, the content treatment system may identify a later unauthorized duplicate digital content item based on a reference indicator included in an earlier unauthorized duplicate digital content item. In some instances, the content treatment system stores one or more hashes of digital content items associated with reference identifiers of one or more types in a database record of “potentially copy-able” or “potentially plagiarize-able” digital content items (e.g., digital content items that may be viewed as assets or as valuable property to unauthorized copiers, users, or distributers of original content).

Certain digital content items published on the SNS receives a large number of social gestures, such as likes, shares, comments, followers, etc., and may become viral. In the process of becoming viral, such popular content item become candidates for unauthorized re-publication on the SNS. In certain example embodiments, the content treatment system accesses, at the record of the database, a viral digital content item. The content treatment system determines that the viral digital content item is associated with a number of social gesture indicators that is equal to or exceeds a social gesture threshold value. The content treatment system generates a hash of the viral digital content item based on applying a hash function to the viral digital content item. The generating of the hash is based on the determining that the viral digital content item is associated with the number of social gesture indicators that is equal to or exceeds the social gesture threshold value. The content treatment system stores the hash in a hash cluster, at a further record of the database. The hash cluster may include a plurality of hashes associated with digital content items that are potentially plagiarized. The content treatment system may use the plurality of hashes in real-time identifying of potentially plagiarized digital content items (e.g., during the online phase).

In some example embodiments, the content treatment system may add to the hash cluster hashes of digital content items posted by members with large numbers of connections in theirs social graphs on the SNS. In some instances, members with a number of connections that equals or exceeds a threshold number of connections engage in unauthorized copying and re-publishing of content created by other people. Such members may be interested in increased exposure on the SNS, and may attempt to accomplish that by generating virality to content that they publish on the SNS. Such members may identify original digital content items that are worthy of copying and re-posting on the SNS, and may propagate the copied content to their many connections on the SNS. Their connections (e.g., other members of the SNS), in turn, may continue to propagate the copied content. As such, digital content items posted by members with large numbers of connections are candidates for unauthorized re-publication on the SNS.

In certain example embodiments, the content treatment system accesses, at the record of the database, a digital content item. The content treatment system determines that the digital content item is published by a member associated with a number of connections via a social graph of the SNS that is equal to or exceeds a connection number threshold value. The content treatment system generates a hash of the digital content item based on applying a hash function to the digital content item. The generating of the hash is based on the determining that the digital content item is published by the member associated with the number of connections via the social graph of the SNS that is equal to or exceeds the connection number threshold value. The content treatment system stores the hash in a hash cluster, at a further record of the database. The hash cluster may include a plurality of hashes associated with digital content items that are potentially plagiarized. The content treatment system may use the plurality of hashes in real-time identifying of potentially plagiarized digital content items (e.g., during the online phase).

In some example embodiments, the content treatment system generates a plurality of hash clusters, wherein each hash cluster includes a plurality of hashes of similar digital content items. In some instances, a first hash cluster, generated and maintained by the content treatment system, includes a first original digital content item and one or more digital content items that are unauthorized duplicates of the first original digital content item. A second hash cluster, generated and maintained by the content treatment system, includes a second original digital content item and one or more digital content items that are unauthorized duplicates of the second original digital content item. The content treatment system, in some instances, generates or updates the plurality of hash clusters during the offline phase, and utilizes the plurality of hash clusters as basis for analysis of a hash of a recently received (e.g., uploaded, posted, or published) digital content item during the online phase to determine whether the recently received digital content item is a near-duplicate of an original content item.

The content treatment system may additionally follow the offline flow to identify the original digital content item in a hash cluster, and the original author of the original digital content item. The content treatment system may also execute one or more treatments pertaining to the members who posted unauthorized duplicate content items on the SNS based on identifying the member IDs associated with the hashes included in the hash cluster that are not associated with the original digital content item. The one or more treatments may be selected based on a copying violation score value associated with the respective members. The copying violation score value may be generated (or updated) based on whether the member posted unauthorized digital content on the SNS, the number of copying violations associated with the respective member, whether the unauthorized copying and re-posting of digital content was accompanied by reference identifiers of the original author or source, whether the member has prior fraudulent behavior on the SNS, etc. In some instances, the copying violation score value of original content authors (e.g., influencers on LinkedIn®) is below a certain threshold value, while the copying violation score value of a member who is identified as an unauthorized copier of digital content is equal to or exceeds the certain threshold value.

In some example embodiments, there is an overlap (e.g., a time overlap, a functionality overlap, etc.) between one or more of the online phase, the nearline phase, or the offline phase. In various example embodiments, results of analyses or treatments performed in one of the phases may be used as input in the analysis or selection of treatments in one or both of the other phases. In certain example embodiments, two or more of the online phase, the nearline phase, or the offline phase are executed in parallel.

One or more servers of the content treatment system are enhanced by the operations performed during the online phase, nearline phase, or offline phase, or a suitable combination thereof. For example, the pre-processing of data rising pattern matching and hash matching facilitates faster processing times by one or more servers of the SNS, which allows for a speedier identification of potentially plagiarizing digital content on the SNS. According to another example that illustrates how the content treatment system is improved, the selecting and applying of treatments to unauthorized duplicate digital content based on various types of unauthorized copying of original content facilitates a de-duplication of redundant data in one or more database records associated with the SNS, and, accordingly, provides a more efficient storage system for the data pertaining to digital content items published on the SNS.

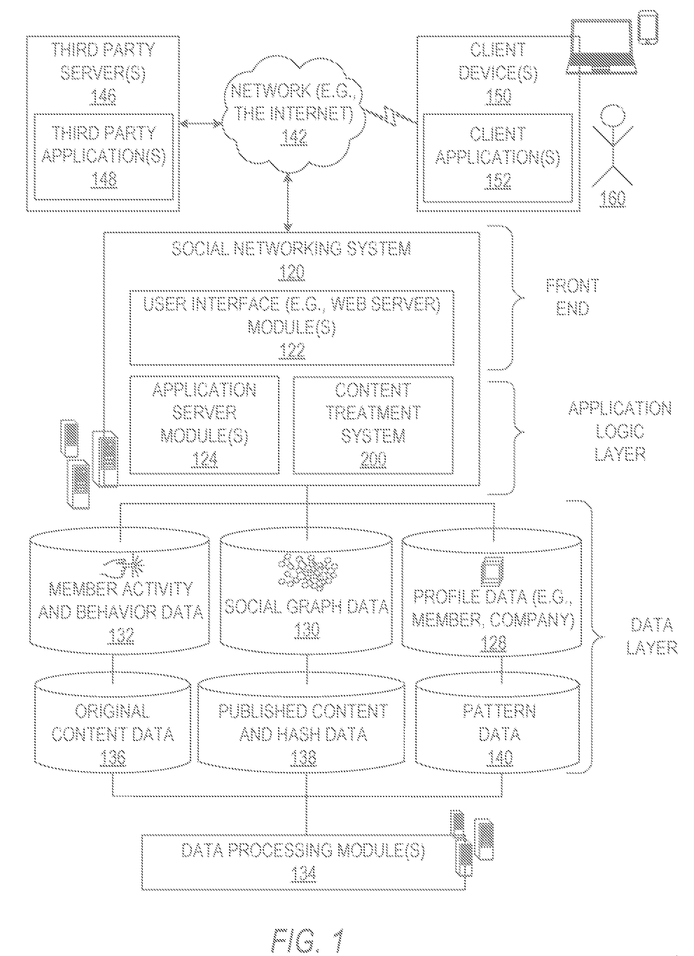

An example method and system for detecting and treating unauthorized duplicate digital content may be implemented in the context of the client-server system illustrated in FIG. 1. As illustrated in FIG. 1, the content treatment system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depleted in FIG. 1 may reside on a single server computer, or may be distributed across several server computers in various arrangements. Moreover, although depicted in FIG. 1 as a three-tiered architecture, the inventive subject matter is by no means limited to such architecture.

As shown its FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client applications(s) 152. The client applications(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members internet with various applications, content, and user interfaces of the social networking system 120, information relating to the member's activity and behavior may be stored in a database, such as the database 132. An example of such activity and behavior data is the identifier of an online ad consumption event associated with the member (e.g., an online ad viewed by the member), the date and time when the online ad event took place, an identifier of the creative associated with the online ad consumption event, a campaign identifier of an ad campaign associated with the identifier of the creative, etc.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the SNS may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive digital communications (e.g., advertising, news, status updates, etc.) targeted to them based on various factors (e.g., member profile data, social graph data, member activity or behavior data, etc.)

The application logic lager includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For example, an ad serving engine showing ads to users may be implemented with one or more application server modules 124. According to another example, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the data migration system 200, which is described in more detail below.

Further, as shown in FIG. 1, a data processing module 134 may be used with a variety of applications, services, and features of the social networking system 120. The data processing module 134 may periodically access one or more of the databases 128, 130, 132, 130, 138, or 140, process (e.g., execute catch process jobs to analyze or mine) profile data, social graph data, member activity and behavior data, original content data (e.g., the content of items of digital content determined to be original to (e.g., authored by) the member who published the content), published content data (e.g., the content of items of digital content published on the SNS), content hash data (e.g., hashes of digital content items), or pattern data (e.g., a pattern such as “# copied”), and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

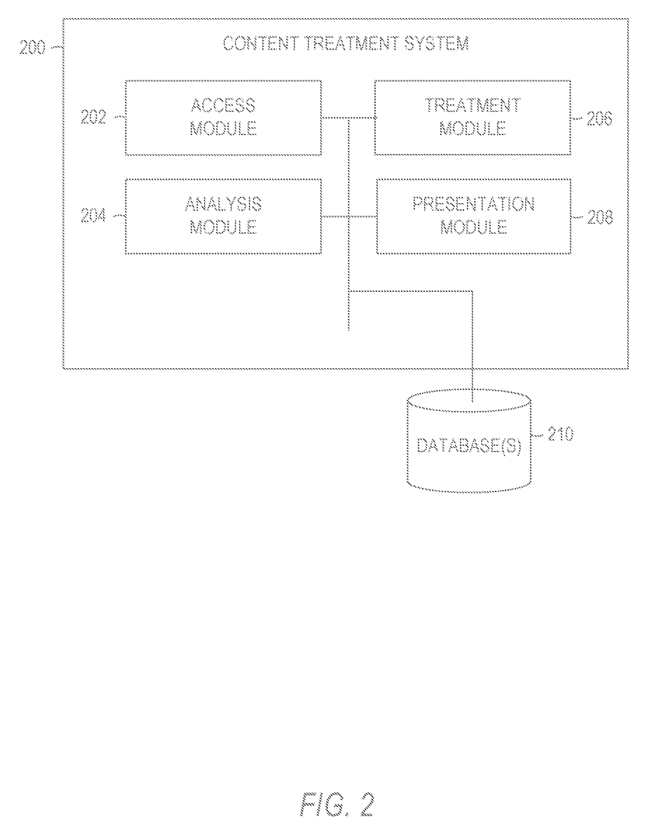

FIG. 2 is a block diagram illustrating components of the content treatment system 200, according to some example embodiments. As shown in FIG. 2, the content treatment system 200 includes an access module 202, an analysis module 204, a treatment module 206, and a presentation module 208, all configured to communicate with each other (e.g., via a bus, shared memory, or a switch).

According to some example embodiments, the access module 202 accesses, at a record of a database, a digital content item. The digital content item may be published on a server of a social networking service (SNS) by a member of the SNS.

The analysis module 204 determines that the digital content item does not include a reference indicator. The reference indicator indicates that the digital content item is copied original content. The determining that the digital content item does not include a reference indicator may be based on pattern matching. The analysis of the digital content item may be a textual analysis, an image analysis, a video analysis, etc.

for example, the analysis module 204, during the analysis of the digital content item, compares text associated with (e.g., included in) the digital content item and one or more text patterns (e.g., alphanumeric strings), such as “# copied,” that indicate that the associated text is not original to the publisher of the digital content item. The analysis module 204 may or may not identify a reference indicator, such as “# copied,” in the digital content item.

The analysis module 204 determines that the digital content item is at least one of a near-duplicate or an exact duplicate of an original digital content item stored in the record of the database based on a comparison between data pertaining to the digital content item and data pertaining to the original digital content item. The determining that the digital content item is at least one of a near-duplicate or an exact duplicate of an original digital content item may be performed in response to the determining that the digital content item does not include the reference indicator.

The treatment module 206 enhances the server of the SNS based on executing a treatment of the digital content item. The treatment of the digital content item may be based on the determining that the digital content item is at least one of the near-duplicate or the exact duplicate of the original digital content item. The executing of the treatment may include causing an automatic alteration of a state associated with the digital content item in the record of the database.

The presentation module 208 causes a display of a communication (e.g., an alert, a report, a notification, etc.) in a use interface of a client device on an administrator of the content treatment system 200. The communication may be based on the determining that the digital content item is at least one of the near-duplicate or the exact duplicate of the original digital content item. In some instances, the presentation module 208 selects a type of communication to be displayed in the user interface based on whether the digital content item is a near-duplicate or an exact duplicate of the original digital content item.

To perform one or more of its functionalities, the content treatment system 200 may communicate with one or more other systems. For example, an integration system may integrate the content treatment system 200 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more hardware processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 210 (e.g., database 128, 130, 132, 136, 138, or 140).

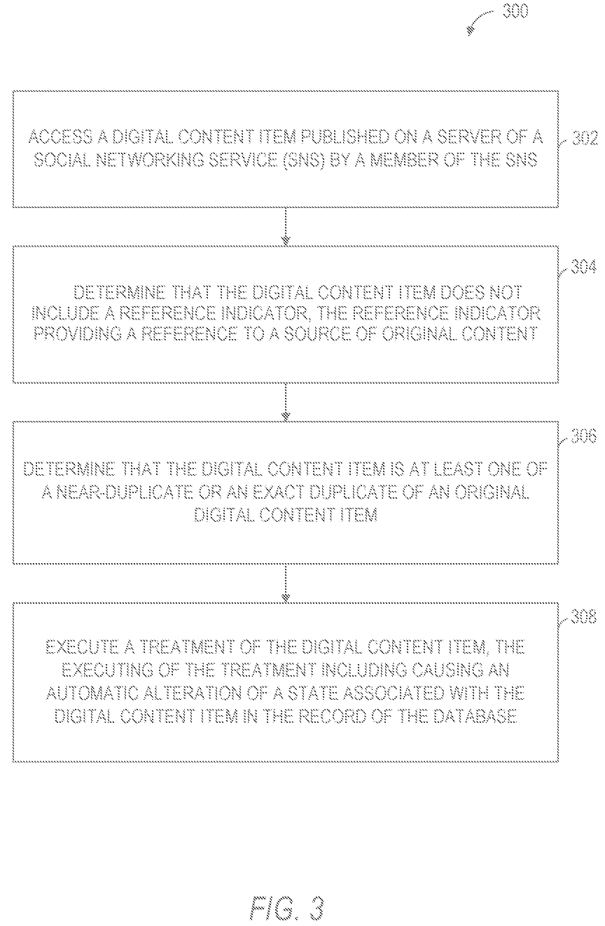

FIGS. 3-12 are flowcharts illustrating a method for detecting and treating unauthorized duplicate digital content, according to some example embodiments. Operations in the method 300 illustrated in FIG. 3 may be performed using modules described above with respect to FIG. 2. As shown in FIG. 3, method 300 may include one or more of method operations 302, 304, 306, and 308, according to some example embodiments.

At operation 302, the access module 202 accesses, at a record of a database, a digital content item. The digital content item is published on a server of the SNS by a member of the SNS.

At operation 304, the analysis module 204 determines that the digital content item does not include a reference indicator that indicates that the digital content item is copied original content. For example, the reference indicator is a string of characters, such as “# copied” that indicates that the digital content item is not an original digital content item. In some instances, the reference indicator may provide a reference to a source of original content (e.g., “# copiedfromXYZ”).

In some example embodiments, the determining that the digital content item does not include a reference indicator is based on pattern matching. For example, the analysis module 204, during the analysis of the digital content item, compares text associated with (e.g., included in) the digital content item and one or more text patterns (e.g., alphanumeric strings), such as “# copied,” that indicate that the associated text is not original to the publisher of the digital content item. The analysis module 204 may or may not identify a reference indicator, such as “# copied,” in the digital content item.

At operation 300, the analysis module 204 determines that the digital content item is at least one of a near-duplicate or an exact duplicate of an original digital content item stored in the record of the database based on a comparison between data pertaining to the digital content item and data pertaining to the original digital content item. The data access module 202 may access the original digital content item from a database record that stores one or more original digital content items. The determining that the digital content item is at least one of a near-duplicate or an exact duplicate of an original digital content item may be performed In response to the determining that the digital content item does not include the reference indicator.

In some example embodiments, before the analysis module 204 determines that the digital content item is at least one of a near-duplicate or an exact duplicate of the original digital content item, the analysis module 204 identifies the digital content item based on accessing a digital publication (e.g., a message published in a feed), and removing Personal Identifiable Information (PII) from the digital publication. The removing of the PII results in a PII-free digital content item. In some example embodiments, the analysis module 204 then performs a canonicalization operation on the PII-free digital content item. The performing of the canonicalization operation results in the digital content item.

At operation 308, the treatment module 206 enhances the server based on executing a treatment of the digital content item. The treatment of the digital content item is based on the determining that the digital content item is at least one of the near-duplicate or the exact duplicate of the original digital content item. The executing of the treatment includes causing an automatic alteration of a state associated with the digital content item in the record of the database.

In some example embodiments, the treatment module 200 selects the treatment based on at least a type of unauthorized copying of the digital content item, a number of instances of unauthorized copying associated with the member who performed the unauthorized copying of the digital content item, or a member plagiarism score value associated with the member.

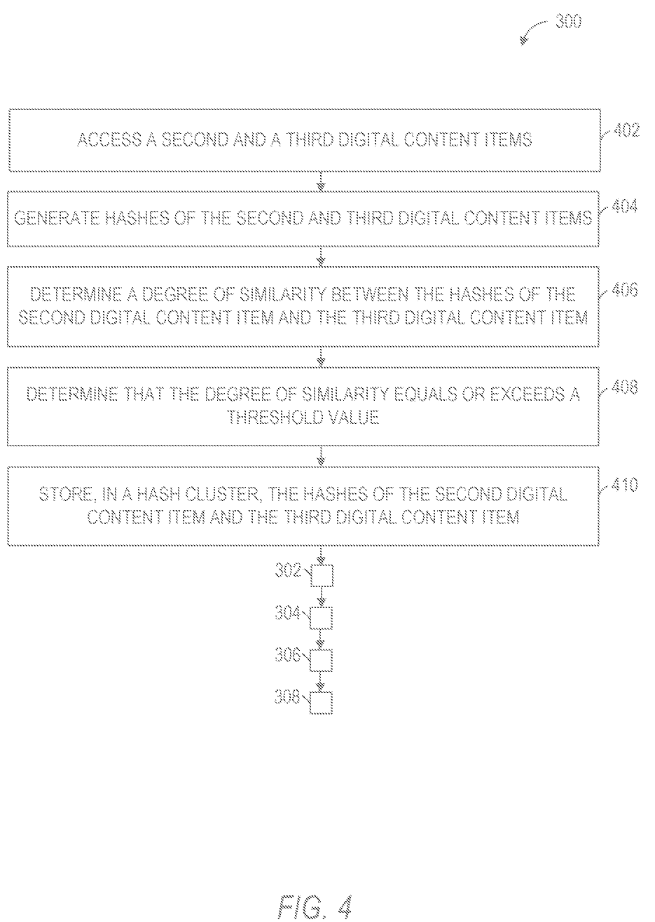

Further details with respect to the method operations of the method 300 are described below with respect to FIGS. 4-10.

As shown in FIG. 4, the method 300 may include one or more method operations 402, 404, 406, 408, or 410, according to some example embodiments. Operation 402 may be performed before operation 302, in which the access module 202 accesses, at the record of the database, the digital content item.

At operation 402, the access module 202 accesses, at the record of the database, a second digital content item and a third digital content item.

At operation 404, the analysis module 204 generates a hash of the second digital content item and a hash of the third digital content item based on applying a hash function to the second digital content item and the third digital content item. The generating of the hash of the digital content item may be based on performing locality-sensitive hashing of the digital content item, min hashing, etc.

At operation 406, the analysis module 204 determines a degree of similarity between the hashes of the second digital content item and the third digital content item. In some example embodiments, the degree of similarity between two digital content items is represented by a probability that the two digital content items are near-duplicate of each other. The probability may be generated based on matching the hashes of the two digital content items (e.g., mapping the hash of the second digital content item to the hash of the third digital content items).

In sense example embodiments, the mapping of the hashes is performed based on locality-sensitive hashing, an algorithm for solving the approximate or exact Near Neighbor Search in high dimensional spaces. According to this approach, a message is hashed a plurality of times, so that similar messages are more likely to be hashed to the same bucket of hashes (e.g., group of hashes).

For example, minhash signatures for the user reported messages is accessed, the signature matrix is divided into ‘b’ bands consisting of ‘r’ rows each. For each band, there is a hash function that takes vectors of ‘r’ integers (e.g., the portion of one column within that band) and hashes them to some large number of buckets. The underlying assumption is that most of the dissimilar pairs will never hash to the same bucket.

In some example embodiments, the mapping of the hashes is performed based on using a Jaccard Index. The Jaccard coefficient measures similarity between finite sample sets, and is defined as the size of the intersection divided by the size of the union of the sample sets.

At operation 408, the analysis module 204 determines that the degree of similarity between the hashes of the second digital content item and the third digital content item equals or exceeds a threshold value.

At operation 410, the analysis module 204 stores the hashes of the second digital content item and the third digital content item in a hash cluster at a further record of the database. The storing of the hash of the second digital content item and the hash of the third digital content item in the hash cluster is based on the determining that the degree of similarity between the hashes of the second digital content item and the third digital content item equals or exceeds a threshold value. The hashes may be stored in association with respective time stamps that correspond to times of publishing of the second digital content item and the third digital content item on the server of the SNS, and with identifiers of members of the SNS who published the second digital content item and the third digital content item.

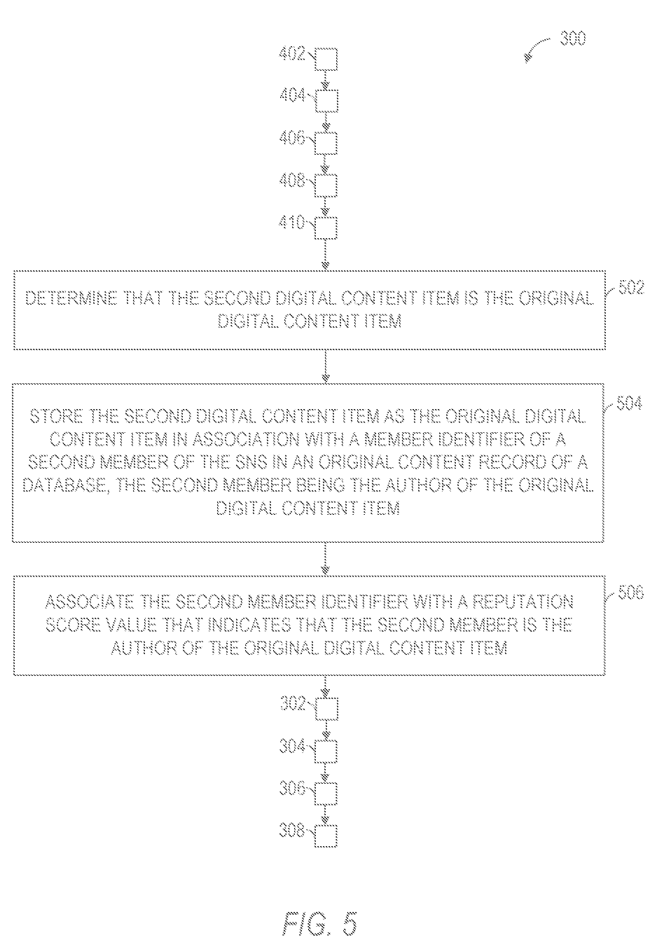

As shown in FIG. 5, the method 300 may include one or more method operations 502 or 504, according to some example embodiments. Operation 502 is performed after operation 410 of FIG. 4, in which the analysis module 204 stores the hashes of the second digital content item and the third digital content item in a hash cluster at a further record of the database, and before operation 302, in which the access module 202 accesses the digital content item at the record of the database.

At operation 502, the analysis module 204 determines that the second digital content item is the original digital content item. The determining that the second digital content item is the original digital content item may be based on a time stamp associated with the hash of the second digital content item, a reputation value associated with the member who posted (e.g., published) the original digital content item, or a combination thereof.

At operation 504, the analysis module 204 stores the second digital content item as the original digital content item in association with a member identifier of a second member of the SNS in an original content record of the database. The second member is the author of the original digital content item (e.g., with the member who published the original digital content item).

At operation 506, the analysis module 204 associates the second member identifier with a reputation score value that indicates that the second member is the author of the original digital content item. In some instances, if the second member identifier is already associated with a reputation score value, the existing reputation score value is adjusted (e.g., increased) based on the determination that the second digital content item is the original digital content item, and based on the second digital content item being published by the second member (e.g., the second member being the author of the second digital content item).

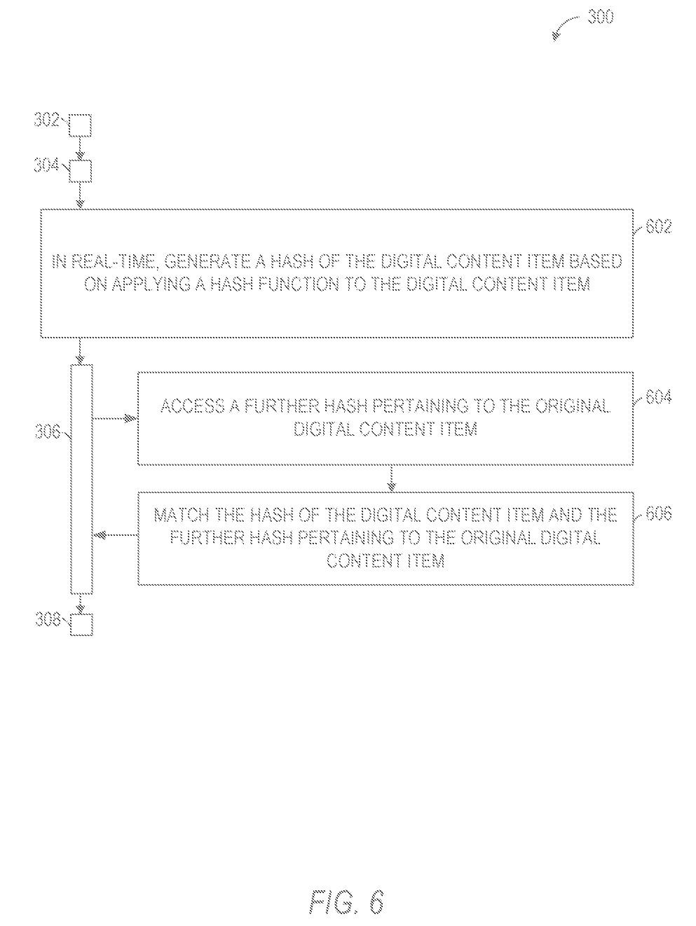

As shown in FIG. 6, the method 300 may include one or more method operations 602, 604, or 606, according to some example embodiments. Operation 602 may be performed after operation 304 of FIG. 3, in which the analysis module 204 determines that the digital content item does not include a reference indicator that indicates that the digital content item is copied original content. At operation 602, the analysis module 204, in real-time, generates a hash of the digital content item based on applying a hash function to the digital content item.

Operation 604 may be performed as part (e.g., a precursor task, a subroutine, or a portion) of operation 306 of FIG. 3, in which the analysis module 204 determines that the digital content item is at least one of a near-duplicate or an exact duplicate of an original digital content item stored in the record of the database based on a comparison between data pertaining to the digital content item and data pertaining to the original digital content item.

In some example embodiments, the determining that the digital content item is the near-duplicate of the original digital content item is performed in real-time. At operation 604, the analysis module 204 accesses a further hash pertaining to the original digital content item. The further hash pertaining to the original digital content item may be generated based on applying a hash function to the original digital content item, before the digital content item is accessed from the record of the database by the access module 202.

At operation 606, the analysis module 204 matches the hash of the digital content item and the further hash pertaining to (e.g., of) the original digital content item. The matching of the hash of the digital content item and the further hash may be performed in real time, and may include determining that the degree of similarity between the hash of the digital content item and the hash of the original digital content item equals or exceeds a threshold value.

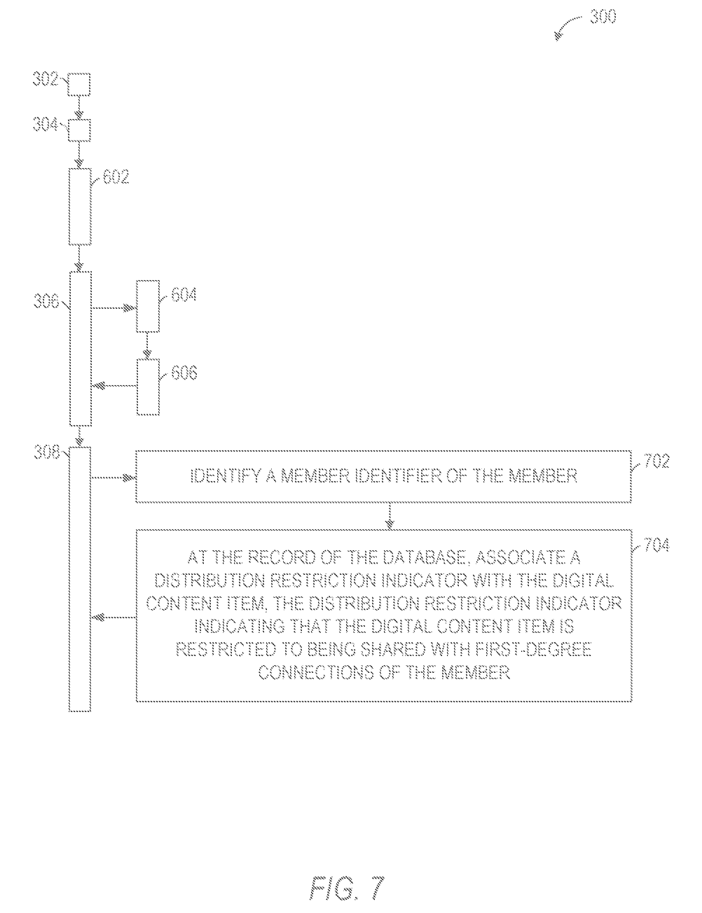

As shown in FIG. 7, the method 300 may include operations 702 or 704, according to some example embodiments. Operation 702 may be performed as part (e.g., a precursor task, a subroutine, or a portion) of operation 308 of FIG. 6, in which the treatment module 206 enhances the server based on executing a treatment of the digital content item, and after operations 606 of FIG. 6, in which the analysis module 204 matches the hash of the digital content item and the further hash pertaining to (e.., of) the original digital content item.

In some example embodiments, the causing of the automatic alteration of the state associated with the digital content item in the record of the database includes identifying, by the treatment module 206, at operation 702, a member identifier of the member of the SNS based on the data pertaining to the digital content item at the record of the database, and, at the record of the database, associating, by the treatment module 206, at operation 704, a distribution restriction indicator (e.g., a tag) with the digital content item. The distribution restriction indicator indicates that the digital content item is restricted to being shared with first-degree connections of the member of the SNS in a social graph of the member of the SNS.

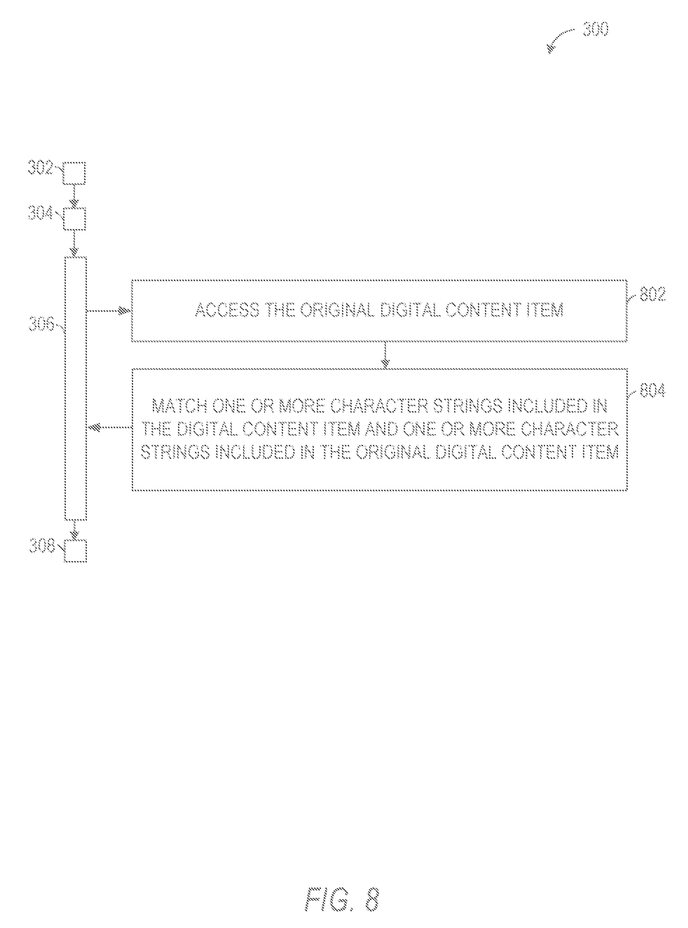

As shown in FIG. 8, the method 300 may include one or more operations 802 or 804, according to some example embodiments. Operation 802 may be performed as part (e.g., a precursor task, a subroutine, or a portion) of operation 306, of FIG. 3, in which the analysis module 204 determines that the digital content item is at least one of a near-duplicate or an exact duplicate of an original digital content item stored in the record of the database based on a comparison between data pertaining to the digital content item and data pertaining to the original digital content item.

In some example embodiments, the determining that the digital content item is the exact duplicate of the original digital content item includes: accessing, by the analysis module 204, at operation 802, the original digital content item at a further record of the database, and matching, by the analysis module 204, at operation 804, one or more character strings included in the digital content item and one or more character strings included In the original digital content item.

In some instances, the determining that the digital content item is the exact duplicate of the original digital content item is performed based on (e.g., in response to, or after) a determination that the digital content item is the near-duplicate of the original digital content item.

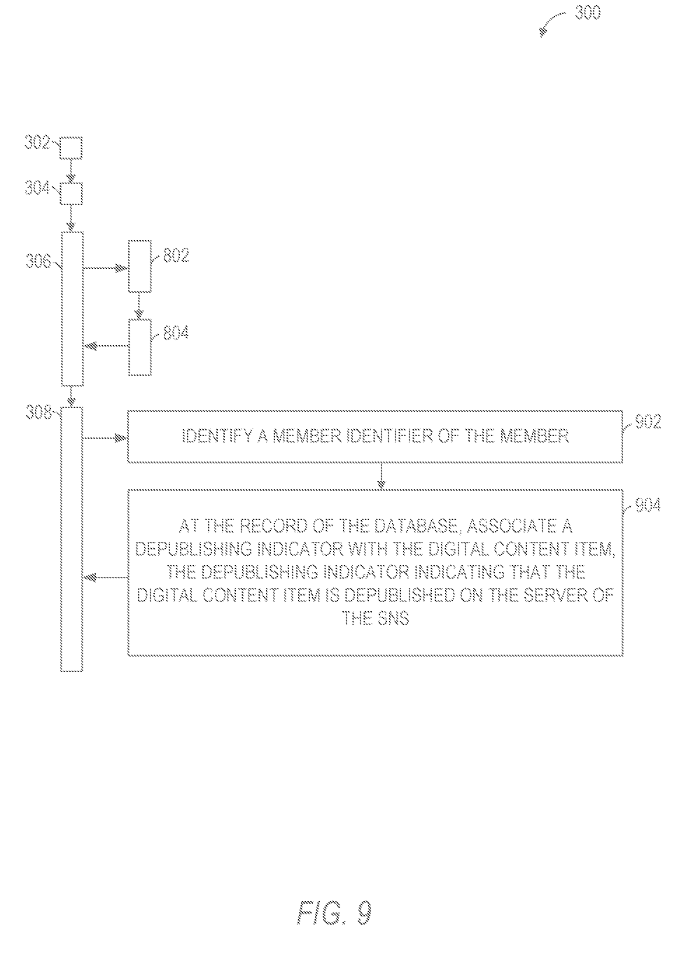

As shown in FIG. 9, the method 300 may include one or more of the method operations 902 or 904, according to some example embodiments. Operation 902 may be performed as part (e.g., a precursor task, a subroutine, or a portion) of operation 308 of FIG. 8, in which the treatment module 206 enhances the server based on executing a treatment of the digital content item, and after operation 804 of FIG. 8 the analysis module 204 matches one or more character strings included in the digital content item and one or more character strings included in the original digital content item.

In some example embodiments, the causing of the automatic alteration of the state associated with the digital content item in the record of the database includes: identifying, by the treatment module 206, at operation 902, a member identifier of the member of the SNS based on the data pertaining to the digital content item at the record of the database, and, at the record of the database, associating, by the treatment module 206, at operation 904, a depublishing indicator (e.g., a tag) with the digital content item. The depublishing indicator indicates that the digital content item is depublished on the server of the SNS.

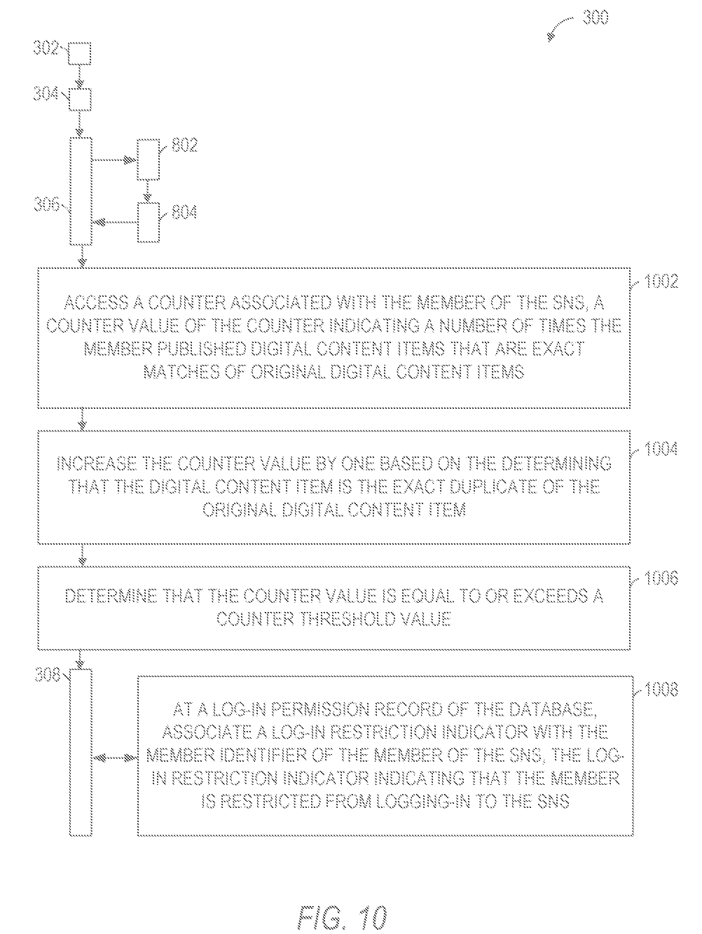

As shown in FIG. 10, the method 300 may include one or more of the method operations 1002, 1004, 1006, or 1008, according to some example embodiments. Operation 1002 may be performed after operation 804 of FIG. 8, in which the analysis module 204 matches one or more character strings included in the digital content item and one or more character strings included in the original digital content item.

At operation 1002, the analysts module 204 accesses a counter associated with the member of the SNS at a further record of a database. A counter value of the counter indicates a number of times the member published digital content items that are exact matches of original digital content items.

At operation 1004, the analysis module 204 increases the counter value by one based on the determining that the digital content item is the exact duplicate of the original digital content item.

At operation 1006, the analysis module 204 determines that the counter value is equal to or exceeds a counter threshold value.

Operation 1008 may be performed as part of operation 308 of FIG. 8, in which the treatment module 206 enhances the server based on executing a treatment of the digital content item. In certain example embodiments, the causing of the automatic alteration of the state associated with the digital content item in the record of the database includes, at a log-in permission record of the database, associating, by the treatment module 206, at operation 1008, a log-in restriction indicator (e.g., a tag) with the member identifier of the member of the SNS. The log-in restriction indicator indicates that the member is restricted from logging-in to the SNS.

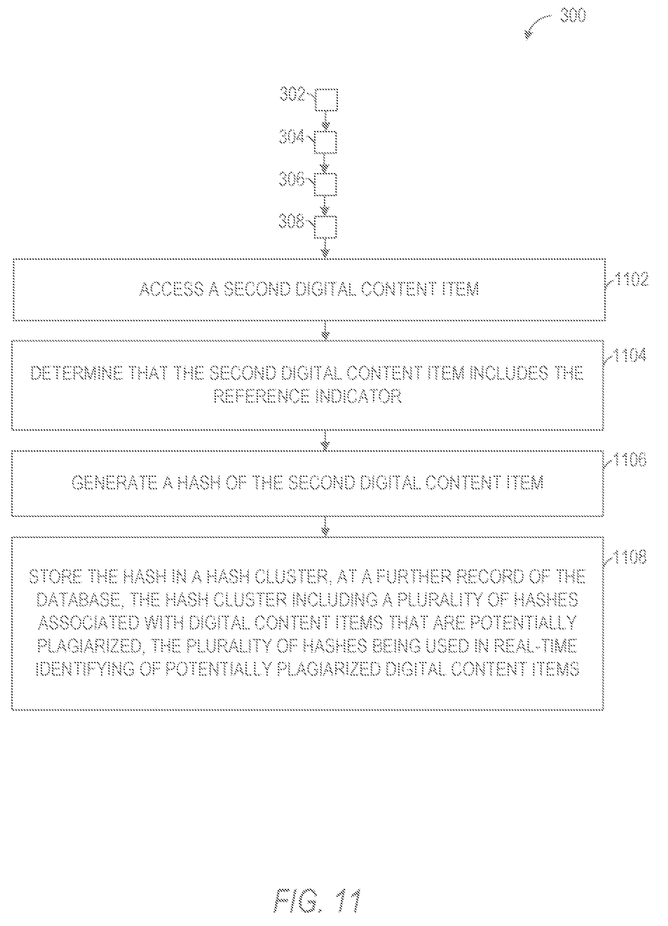

As shown in FIG. 11, the method 300 may include one or more of the method operations 1102, 1104, 1106, or 1108, according to some example embodiments. Operation 1102 may be performed after operation 308 of FIG. 3, in which the treatment module 206 enhances the server based on executing a treatment of the digital content item.

At operation 1102, the access module 202 accesses, at the record of the database, a second digital content item. The second digital content item may be published on the server of the SNS by a second member of the SNS.

At operation 1104 the analysis module 204 determines, based on pattern matching, that the second digital content item includes the reference indicator (e.g., “# copied”).

At operation 1106, the analysis module 204 generates a hash of the second digital content item based on applying a hash function to the second digital content item. The generating of the hash is based on the determining that the second digital content item includes the reference indicator.

At operation 1108, the analysis module 204 stores the hash in a hash cluster, at a further record of the database. The hash cluster includes a plurality of hashes associated with digital content items that are potentially plagiarized (e.g., potentially copied without authorization from the author of the original digital content item). The plurality of hashes may be used in real-time identifying of potentially plagiarized digital content items.

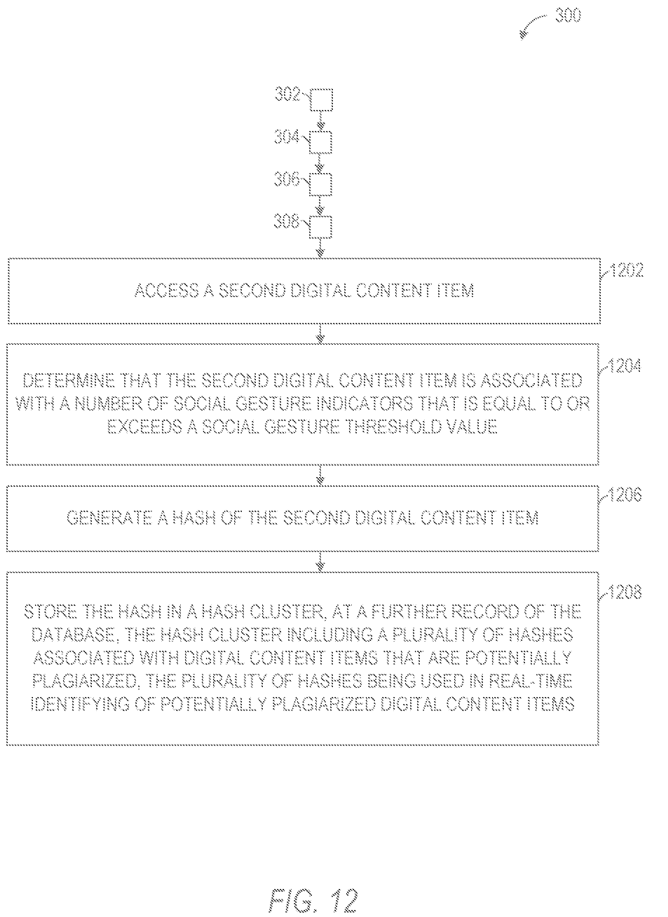

As shown in FIG. 12, the method 300 may include one or more of the method operations 1202, 1204, 1206, or 1208, according to some example embodiments. Operation 1202 may be performed after operation 308 of FIG. 3, in which the treatment module 206 enhances the server based on executing a treatment of the digital content item.

At operation 1202, the access module 202 accesses, at the record of the database, a second digital content item (e.g., a digital content item that has gone viral, or a viral digital content item). The second digital content item may be published on the server of the SNS by a second member of the SNS.

At operation 1204, the analysis module 204 determines that the second digital content item is associated with a number of social gesture indicators (e.g., likes, shares, followers, etc.) that is equal to or exceeds a social gesture threshold value.

At operation 1206, the analysis module 204 generates a hash of the second digital content item based on applying a hash function to the second digital content item. The generating of the hash is based on the determining that the second digital content item is associated with the number of social gesture indicators that is equal to or exceeds the social gesture threshold value.

At operation 1208, the analysis module 204 stores the hash in a hash cluster, at a further record of the database. The hash cluster includes a plurality of hashes associated with digital content items that are potentially plagiarized. The plurality of hashes may be used in real-time identifying of potentially plagiarized digital content items.

### Modules, Components And Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules nave access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment an office environment or as a server farm), while in other embodiments the one or more processors or processor-implemented modules may be distributed across a number of location.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus And System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture And Machine-Readable Medium

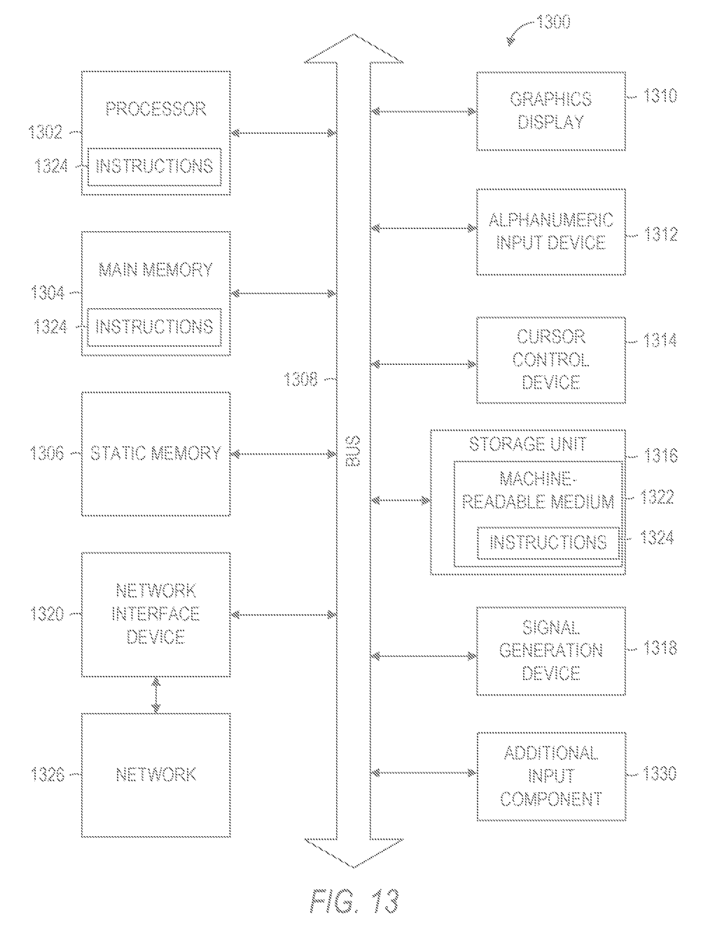

FIG. 13 is a block diagram illustrating components of a machine 1300, according to some example embodiments, able to read instructions 1324 from a machine-readable medium 1322 (e.g., a non-transitory machine-readable medium, a machine-readable storage medium, a computer-readable storage medium, or any suitable combination thereof) and perform any one or more of the methodologies discussed herein, in whole or in part. Specifically, FIG. 13 shows the machine 1300 in the example form of a computer system (e.g., a computer) within which the instructions 1324 (e.g., software, a program, an application, an applet, an app, or other executable code) for causing the machine 1300 to perform any one or more of the methodologies discussed herein may be executed, in whole or in part.

In alternative embodiments, the machine 1300 operates as a standalone device or may be connected (e.g., networked) to other machines. In a networked deployment, the machine 1300 may operate in the capacity of a server machine or a client machine in a server-client network environment, or as a peer machine in a distributed (e.g., peer-to-peer) network environment. The machine 1300 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1324, sequentially or otherwise, that specify actions to be taken by that machine. Further, while only a single machine is illustrated, the term “machine” shall also be taken to include any collection of machines that individually or jointly execute the instructions 1324 to perform all or part of any one or more of the methodologies discussed herein.

The machine 1300 includes a processor 1302 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1304, and a static memory 1306, which are configured to communicate with each other via a bus 1308. The processor 1302 may contain microcircuits that are configurable, temporarily or permanently, by some or all of the instructions 1324 such that the processor 1302 is configurable to perform any one or more of the methodologies described herein, in whole or in part. For example, a set of one or more microcircuits of the processor 1302 may be configurable to execute one or more modules (e.g., software modules) described herein.

The machine 1300 may further include a graphics display 1310 (e.g., a plasma display panel (PDP), a light emitting diode (LED) display, a liquid crystal display (LCD), a projector, a cathode ray tube (CRT), or any other display capable of displaying graphics or video). The machine 1300 may also include an alphanumeric input device 1312 (e.g., a keyboard or keypad), a cursor control device 1314 (e.g., a mouse, a touchpad, a trackball, a joystick, a motion sensor, an eye tracking device, or other pointing instrument), a storage unit 1316, an audio generation device 1318 (e.g., a sound card, an amplifier, a speaker, a headphone jack, or any suitable combination thereof), and a network interface device 1320.

The storage unit 1316 includes the machine-readable medium 1322 (e.g., a tangible and non-transitory machine-readable storage medium) on which are stored the instructions 1324 embodying any one or more of the methodologies or functions described herein. The instructions 1324 may also reside, completely or at least partially, within the main memory 1304, within the processor 1302 (e.g., within the processor's cache memory), or both, before or during execution thereof by the machine 1300. Accordingly, the main memory 1304 and the processor 1302 may be considered machine-readable media (e.g., tangible and non-transitory machine-readable media). The instructions 1324 may be transmitted or received over the network 1326 via the network interface device 1320. For example, the network interface device 1320 may communicate the instructions 1324 using any one or more transfer protocols (e.g., hypertext transfer protocol (HTTP)).

In some example embodiments, the machine 1300 may be a portable computing device, such as a smart phone or tablet computer, and have one or more additional input components 1330 (e.g., sensors or gauges). Examples of such input components 1330 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1324 for execution by the machine 1300, such that the instructions 1324, when executed by one or more processors of the machine 1300 (e.g., processor 1302), cause the machine 1300 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portions) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, at a record of a database, a digital content item, the digital content item being published on a server of a social networking service (SNS) by a member of the SNS;
determining, using one or more hardware processors, that the digital content item does not include a reference indicator that indicates that the digital content item is copied original content;
in response to the determining that the digital content item does not include the reference indicator, determining that the digital content item is at least one of a near-duplicate or an exact duplicate of an original digital content item, stored in the record of the database, based on a comparison between data pertaining to the digital content item and data pertaining to the original digital content item; and
enhancing the server based on executing a treatment of the digital content item, the treatment of the digital content item being based on the determining that the digital content item is at least one of the near-duplicate or the exact duplicate of the original digital content item, the executing of the treatment including causing an automatic alteration of a state associated with the digital content item in the record of the database.

2. The method of claim 1, wherein the digital content item is a first digital content item, the method further comprising:
accessing, at the record of the database, a second digital content item and a third digital content item;
generating hashes of the second digital content item and the third digital content item based on applying a hash function to the second digital content item and the third digital content item;
determining a degree of similarity between the hashes of the second digital content item and the third digital content item;
determining that the degree of similarity between the hashes of the second digital content item and the third digital content item equals or exceeds a threshold value, and
based on determining that the degree of similarity between the hashes of the second digital content item and the third digital content item equals or exceeds a threshold value, storing in a hash cluster, at a further record of the database, the hashes of the second digital content item and the third digital content item, the hashes being stored in association with respective time stamps that correspond to times of publishing of the second digital content item and the third digital content item on the server of the SNS, and with identifiers of members of the SNS who published the second digital content item and the third digital content item.

3. The method of claim 2, further comprising:
determining that the second digital content item is the original digital content item,
storing the second digital content item as the original digital content item in association with a member identifier of a second member of the SNS in an original content record of the database, the second member being the author of the original digital content item; and
associating the second member identifier with a reputation score value that indicates that the second member is the author of the original digital content item.

4. The method of claim 1, further comprising:
in real-time, generating a hash of the digital content item based on applying a hash function to the digital content item,
wherein the determining that the digital content item is the near-duplicate of the original digital content item is performed in real-time and includes,
accessing a further hash pertaining to the original digital content item; and
matching the hash of the digital content item and the further hash pertaining to the original digital content item.

5. The method of claim 4, wherein the causing of the automatic alteration of the state associated with the digital content item in the record of the database includes:
identifying a member identifier of the member of the SNS based on the data pertaining to the digital content item at the record of the database; and
at the record of the database, associating a distribution restriction indicator with the digital content item, the distribution restriction indicator indicating that the digital content item is restricted to being shared with first-degree connections of the member of the SNS in a social graph of the member of the SNS.

6. The method of claim 1, wherein the determining that the digital content item is the exact duplicate of the original digital content item includes:
accessing, at a further record of the database, the original digital content item; and
matching one or more character strings included in the digital content item and one or more character strings included in the original digital content item.

7. The method of claim 6, wherein the determining that the digital content item is the exact duplicate of the original digital content item is performed based on a determination that the digital content item is the near-duplicate of the original digital content item.

8. The method of claim 6, wherein the causing of the automatic alteration of the state associated with the digital content item in the record of the database includes:
identifying a member identifier of the member of the SNS based on the data pertaining to the digital content item at the record of the database; and
at the record of the database, associating a depublishing indicator with the digital content item, the depublishing indicator indicating that the digital content item is depublished on the server of the SNS.

9. The method of claim 6, further comprising:
accessing a counter associated with the member of the SNS, a counter value of the counter indicating a number of times the member published digital content items that are exact matches of original digital content items;
increasing the counter value by one based on the determining that the digital content item is the exact duplicate of the original digital content item; and
determining that the counter value is equal to or exceeds a counter threshold value,
wherein the causing of the automatic alteration of the state associated with the digital content item in the record of the database includes:
at a log-in permission record of the database, associating a log-in restriction indicator with the member identifier of the member of the SNS, the logon restriction indicator indicating that the member is restricted from logging-in to the SNS.

10. The method of claim 1, wherein the digital content items is a first digital content item, the method further comprising:
accessing, at the record of the database, a second digital content item, the second digital content item being published on the server of the SNS by a second member of the SNS;
determining, based on pattern matching, that the second digital content item includes the reference indicator,
generating a hash of the second digital content item based on applying a hash function to the second digital content item, the generating of the hash being based on the determining that the second digital content item includes the reference indicator; and
storing the hash in a hash cluster, at a further record of the database, the hash cluster including a plurality of hashes associated with digital content items that are potentially plagiarized, the plurality of hashes being used in real-time identifying of potentially plagiarized digital content items.

11. The method of claim 1, further comprising:
accessing, at the record of the database, a second digital content item, the second digital content item being published on the server of the SNS by a second member of the SNS,
determining that the second digital content item is associated with a number of social gesture indicators that is equal to or exceeds a social gesture threshold value;
generating a hash of the second digital content item based on applying a hash function to the second digital content item, the generating of the hash being based on the determining that the second digital content item is associated with the number of social gesture indicators that is equal to or exceeds the social gesture threshold value; and
storing the hash in a hash cluster, at a further record of the database, the hash cluster including a plurality of hashes associated with digital content items that are potentially plagiarized, the plurality of hashes being used in real-time identifying of potentially plagiarized digital content items.

12. The method of claim 1, wherein the treatment is selected based on at least a type of unauthorized copying of the digital content item, a number of instances of unauthorized copying associated with the member who performed the unauthorized copying of the digital content item, or a member plagiarism score value associated with the member.

13. The method of claim 1, wherein the determining that the digital content item does not include the reference indicator is based on pattern matching.

14. The method of claim 1, further comprising:
accessing, at the record of the database, a second digital content item,
determining that the digital content item is published by a member associated with a number of connections via a social graph of the SNS that is equal to or exceeds a connection number threshold value;
generating a hash of the second digital content item based on applying a hash function to the second digital content item, the generating of the hash being based on the determining that the digital content item is published by the member associated with the number of connections via the social graph of the SNS that is equal to or exceeds the connection number threshold value; and
storing the hash in a hash cluster, at a further record of the database, the hash cluster including a plurality of hashes associated with digital content items that are potentially plagiarized, the plurality of hashes being used in real-time identifying of potentially plagiarized digital content items.

15. A system comprising:
one or more hardware processors; and
a machine-readable medium for storing instructions that, when executed by the one or more hardware processors, cause the one or more hardware processors to perform operations comprising:
accessing, at a record of a database, a digital content item, the digital content item being published on a server of a social networking service (SNS) by a member of the SNS,
determining that the digital content item does not include a reference indicator that indicates that the digital content item is copied original content;
in response to the determining that the digital content item does not include the reference indicator, determining that the digital content item is at least one of a near-duplicate or an exact duplicate of an original digital content item, stored in the record of the database, based on a comparison between data pertaining to the digital content item and data pertaining to the original digital content item; and
enhancing the server based on executing a treatment of the digital content item, the treatment of the digital content item being based on the determining that the digital content item is at least one of the near-duplicate or the exact duplicate of the original digital content item, the executing of the treatment including causing an automatic alteration of a state associated with the digital content item in the record of the database.

16. The system of claim 15, wherein the digital content item is a first digital content item, and wherein the operations further comprise:
accessing, at the record of the database, a second digital content item and a third digital content item;
generating hashes of the second digital content item and the third digital content item based on applying a hash function to the second digital content item and the third digital content item;
determining a degree of similarity between the hashes of the second digital content item and the third digital content item;
determining that the degree of similarity between the hashes of the second digital content item and the third digital content item equals or exceeds a threshold value; and
based on determining that the degree of similarity between the hashes of the second digital content item and the third digital content item equals or exceeds a threshold value, storing in a hash cluster, at a further record of the database, the hashes of the second digital content item and the third digital content item, the hashes being stored in association with respective time stamps that correspond to times of publishing of the second digital content item and the third digital content item on the server of the SNS, and with identifiers of members of the SNS who published the second digital content item and the third digital content item.

17. The system of claim 16, wherein the operations further comprise:
determining that the second digital content item is the original digital content item,
storing the second digital content item as the original digital content item in association with a member identifier of a second member of the SNS in an original content record of the database, the second member being the author of the original digital content item; and
associating the second member identifier with a reputation score value that indicates that the second member is the author of the original digital content item.

18. The system of claim 15, wherein the operations further comprise:
in real-time, generating a hash of the digital content item based on applying a hash function to the digital content item,
wherein the determining that the digital content item is the near-duplicate of the original digital content item is performed in real-time and includes:
accessing a further hash pertaining to the original digital content item; and
matching the hash of the digital content item and the further hash pertaining to the original digital content item.

19. The system of claim 15, wherein the determining that the digital content item is the exact duplicate of the original digital content item includes:
accessing, at a further record of the database, the original digital content item; and
matching one or more character strings included in the digital content item and one or more character strings included in the original digital content item.

20. A non-transitory machine-readable storage medium comprising instructions that, when executed by one or more hardware processors of a machine, cause the one or more hardware processors to perform operations comprising:
accessing, at a record of a database, a digital content item, the digital content item being published on a server of a soma networking service (SNS) by a member of the SNS;
determining that the digital content item does not include a reference indicator that indicates that the digital content item is copied original content;
in response to the determining that the digital content item does not include the reference indicator, determining that the digital content item is at least one of a near-duplicate or an exact duplicate of an original digital content item, stored in the record of the database, based on a comparison between data pertaining to the digital content item and data pertaining to the original digital content item; and
enhancing the server based on executing a treatment of the digital content item, the treatment of the digital content item being based on the determining that the digital content item is at least one of the near-duplicate or the exact duplicate of the original digital content item, the executing of the treatment including causing an automatic alteration of a state associated with the digital content item in the record of the database.
